(19) United States
(12) Patent Application Publication
(10) Pub. No.: US 2014/0183218 A1
(43) Pub. Date: Jul. 3, 2014

(54) GOODS TRANSMISSION APPARATUS

(71) Applicants: HON HAI PRECISION INDUSTRY CO., LTD., New Taipei (TW); HONG FU JIN PRECISION INDUSTRY (ShenZhen) CO., LTD., ShenZhen (CN)

(72) Inventor: PING SUN, Shenzhen (CN)

(73) Assignees: HONG FU JIN PRECISION INDUSTRY (ShenZhen) CO., LTD., ShenZhen (CN); HON HAI PRECISION INDUSTRY CO., LTD., New Taipeitw (TW)

(21) Appl. No.: 14/050,537

(22) Filed: Oct. 10, 2013

(30) Foreign Application Priority Data
Dec. 28, 2012 (CN) 2012105821138

(51) Int. Cl. G07F 11/24

(52) U.S. Cl. CPC G07F 11/24
USPC 221/277

(57) ABSTRACT

A goods transmission apparatus includes a goods output member and a goods accommodating member. A supporting plate is fixed in the goods output member. An accommodating opening is defined in the supporting plate. The goods accommodating member includes a base plate and a fixing bracket fixed on the base plate. A spring is received in the base plate. A plurality of accommodating spaces is defined between coils of the spring for holding sale items. A driving member is fixed on the fixing bracket. The driving member includes a motor and a pivoting axle. A pivoting hole is defined in the pivoting axle. One end of the spring passes through the pivoting hole to fix the spring to the goods accommodating member. The motor is powered on and drives the spring to rotate by the pivoting axle. A sale item in the spring drops to the goods output member.

### BACKGROUND

1. Technical Field

The present disclosure relates to a goods transmission apparatus in vending machines.

2. Description of Related Art

Vending machines include goods accommodating members for accommodating a plurality of sale items. Typical vending machines use supporting trays to support the sale items. A motor rotates the supporting trays to make the sale items drop to an output tray. However, the supporting trays may respond slowly and sometimes push the incorrect sale item to the output tray.

Therefore, there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a partially exploded, isometric view of an embodiment of a goods transmission apparatus.

FIG. 2 is an enlarged view of a circled portion II of FIG. 1.

FIG. 3 is an assembled view of the goods transmission apparatus of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

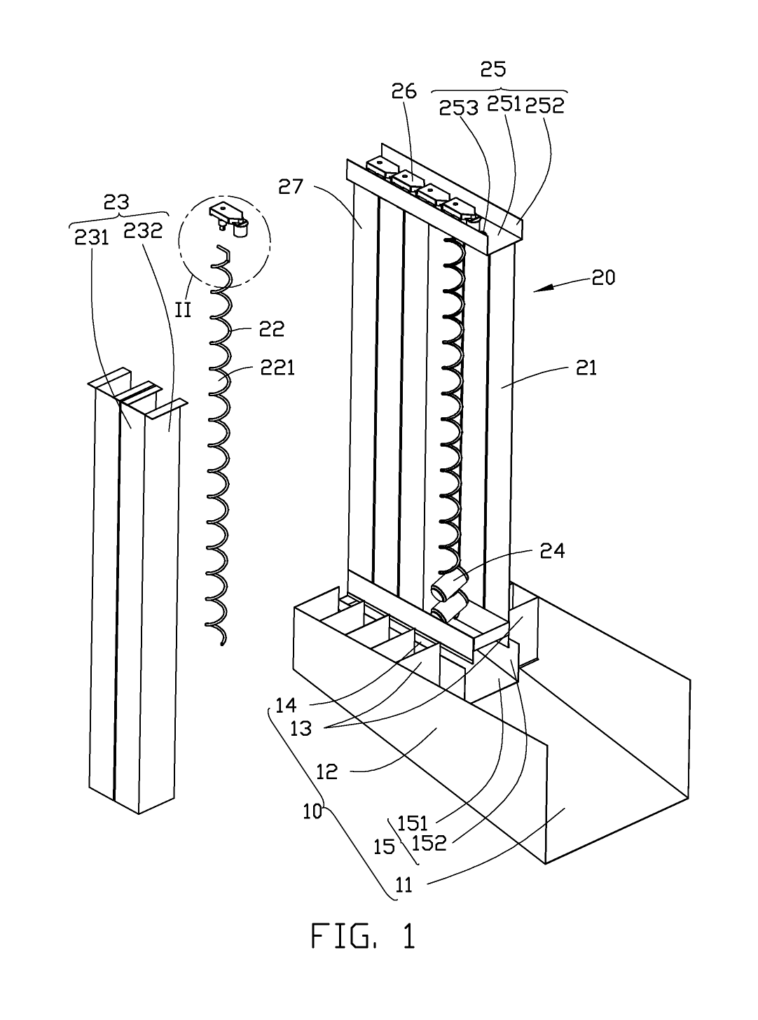

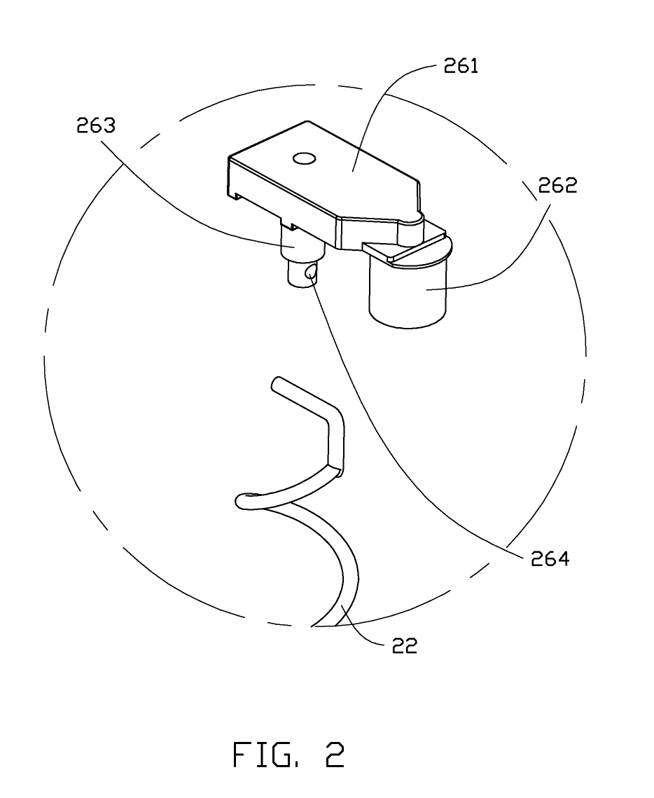

FIGS. 1 and 2 show a goods transmission apparatus of a vending machine. The goods transmission apparatus includes a goods output member 10 and a goods accommodating unit 20 fixed over the goods output member 10. The goods accommodating unit 20 includes a plurality of goods accommodating members 27.

The goods output member 10 includes a first bottom plate 11. Two first side plates 12 substantially perpendicularly extend towards the goods accommodating unit 20 from two sides of the first bottom plate 11, respectively. A goods output channel is cooperatively defined by the first bottom plate 11 and the two first side plates 12. A plurality of supporting plates 13 is fixed on the first bottom plate 11 between the two first side plates 12. The supporting plates 13 are substantially parallel to each other. A substantially rectangular accommodating opening 14 is defined in each of the plurality of supporting plates 13. A goods guiding member 15 is fixedly received in the accommodating opening 14. The goods guiding member 15 includes a second bottom plate 151. Two second side plates 152 extend substantially perpendicularly upwards from two sides of the second bottom plate 151, respectively. A goods guiding channel is cooperatively defined by the second bottom plate 151 and the two second side plates 152. In this embodiment, a width of the accommodating opening 14 is substantially equal to a width of the goods guiding member 15.

Each of the plurality of goods accommodating members 27 includes a base plate 21. A protecting cover 23 is mounted to the base plate 21. A spring 22 is received in an accommodating channel cooperatively defined by the base plate 21 and the protecting cover 23. A plurality of accommodating spaces 221 is defined between coils of the spring 22. A sale item 24 is slantingly positioned in each of the plurality of accommodating spaces 221. The protecting cover 23 includes a connecting plate 231. Two shielding plates 232 extend substantially perpendicularly from two sides of the connecting plate 231, respectively. A fixing bracket 25 is fixed on a top of the plurality of goods accommodating members 27. The fixing bracket 25 includes a third bottom plate 251. Two third side plates 252 respectively extend substantially perpendicularly from two sides of the third bottom plate 251 away from the goods output channel 10. A plurality of cutouts 253 is defined in the third bottom plate 251. A plurality of driving members 26 is fixed on the third bottom plate 251. Each of the plurality of driving members 26 includes a supporting bracket 261. A motor 262 and a pivoting axle 263 are fixed on the supporting bracket 261. A pivoting hole 264 is defined in the pivoting axle 263. In this embodiment, a size of an end of the spring 22 is substantially equal to a size of the pivoting hole 264. A width of the goods accommodating member 27 is substantially equal to a width of the accommodating opening 14.

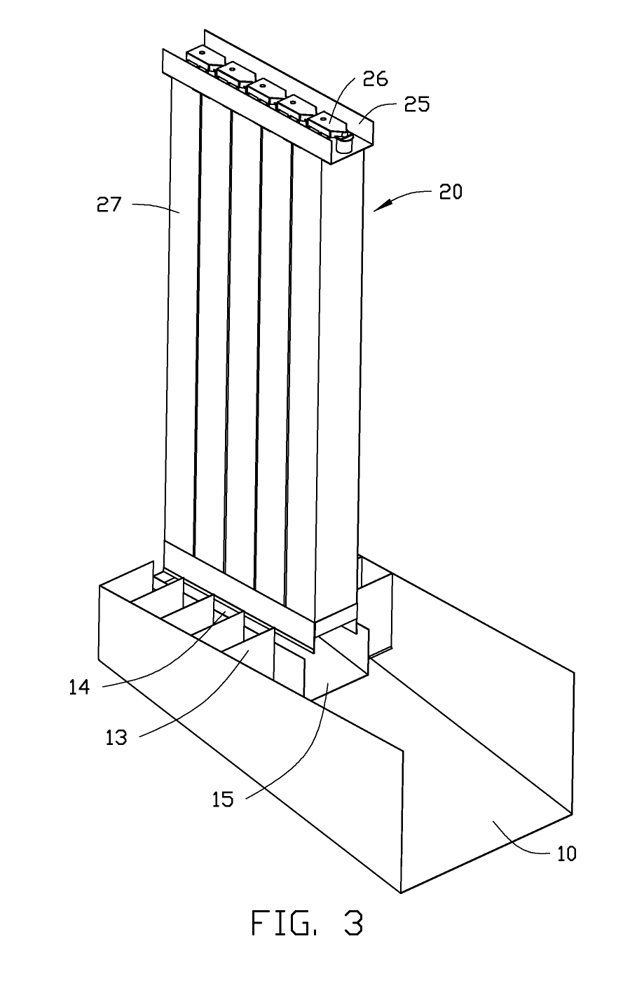

FIGS. 1 to 3 show that in assembly, the pivoting axle 263 of the supporting bracket 261 is received by a corresponding cutout 253. One end of the spring 22 is received by the pivoting hole 264 of the pivoting axle 263, to fix the spring 22 in the corresponding goods accommodating member 27. The protecting cover 23 is mounted to the corresponding base plate 21. The spring 22 and the sale items 24 are covered by the corresponding protecting cover 23. The goods guiding member 15 is located in the accommodating opening 14. The plurality of goods accommodating members 27 are located over the accommodating opening 14. The plurality of goods accommodating members 27 are held between the plurality of supporting plates 13 above the goods guiding member 15.

In operation, the motor 262 is powered on and drives the corresponding spring 22 to rotate by the pivoting axle 263. The sale item 24 in the corresponding spring 22 drops on the goods guiding member 15 and slides to the goods output member 10. The sale item 24 located in an accommodating space 221 at a bottom of the spring 22 drops to the goods guiding member 15 when the spring 22 rotates a circle. Therefore, the possibility of malfunction of the vending machine is reduced.

Even though numerous characteristics and advantages of the present disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. A goods transmission apparatus, comprising:
a goods output member comprising a supporting plate, an accommodating opening being defined in the supporting plate; and
a goods accommodating member located in the accommodating opening; wherein the goods accommodating member comprises a base plate and a fixing bracket; the fixing bracket is fixed on a top of the base plate; a spring is received in the base plate; a plurality of accommodating spaces is defined between coils of the spring for placing sale items; a driving member is fixed on the fixing bracket; the driving member comprises a motor and a pivoting axle; a pivoting hole is defined in the pivoting axle; the spring passes through the pivoting hole in the pivoting axle to fix the spring on the goods accommodating member; when the motor is turned on, the motor drives the spring rotating by the pivoting axle and pushes a sale item on the spring to the goods output member.

2. The goods transmission apparatus of claim 1, wherein the goods output member comprises a first bottom plate; two first side plates extend upwards from two sides of the first bottom plate; and the supporting plate is fixed on the first bottom plate between the two first side plates.

3. The goods transmission apparatus of claim 2, further comprising a goods guiding member fixed in the accommodating opening; the goods guiding member comprises a second bottom plate; and two second side plates extend upwards from two sides of the second bottom plate.

4. The goods transmission apparatus of claim 3, wherein a width of the accommodating opening is equal to a width of the goods guiding member.

5. The goods transmission apparatus of claim 4, further comprising a protecting cover mounted on the base plate; the protecting cover comprises a connecting plate; one shielding plate extends from each side of the connecting plate; and the spring and the sale items are covered by the protecting cover.

6. The goods transmission apparatus of claim 5, wherein the fixing bracket comprises a third bottom plate; a third side plate extends upwards from each side of the third bottom plate; a cutout is defined in the third bottom plate; the driving member is fixed on the third bottom plate; the driving member further comprises a supporting bracket; the motor and the pivoting axle are fixed on the supporting bracket; and the pivoting axle passes through the cutout.

7. The goods transmission apparatus of claim 6, wherein a diameter of the spring is equal to a diameter of the pivoting hole; and a width of the goods accommodating member is equal to a width of the accommodating opening.

8. The goods transmission apparatus of claim 7, wherein the plurality of accommodating spaces are configured to accommodate the sale items diagonally.

9. A goods transmission apparatus, comprising:
a goods output member comprising a supporting plate, an accommodating opening being defined in the supporting plate, a goods guiding member being fixed in the accommodating opening; and
a goods accommodating member located in the accommodating opening; wherein the goods accommodating member comprises a base plate and a fixing bracket; the fixing bracket is fixed on a top of the base plate; a spring is received in the base plate; a plurality of accommodating spaces is defined between coils of the spring for placing sale items; a driving member is fixed on the fixing bracket; the driving member comprises a motor and a pivoting axle; a pivoting hole is defined in the pivoting axle; the spring passes through the pivoting hole in the pivoting axle to fix the spring on the goods accommodating member; when the motor is turned on, the motor drives the spring rotating by the pivoting axle and pushes a sale item on the spring to the goods guiding member and slides the sale item into the goods output member.

10. The goods transmission apparatus of claim 9, wherein the goods output member comprises a first bottom plate; two first side plates extend upwards from two sides of the first bottom plate; and the supporting plate is fixed on the first bottom plate between the two first side plates.

11. The goods transmission apparatus of claim 10, wherein the goods guiding member comprises a second bottom plate; and two second side plates extend upwards from two sides of the second bottom plate.

12. The goods transmission apparatus of claim 11, wherein a width of the accommodating opening is equal to a width of the goods guiding member.

13. The goods transmission apparatus of claim 12, further comprising a protecting cover mounted on the base plate; the protecting cover comprises a connecting plate; a shielding plate extends from each side of the connecting plate; and the spring and the sale items are covered by the protecting cover.

14. The goods transmission apparatus of claim 13, wherein the fixing bracket comprises a third bottom plate; a third side plate extends upwards from each side of the third bottom plate; a cutout is defined in the third bottom plate; the driving member is fixed on the third bottom plate; the driving member further comprises a supporting bracket; the motor and the pivoting axle are fixed on the supporting bracket; and the pivoting axle passes through the cutout.

15. The goods transmission apparatus of claim 14, wherein a diameter of the spring is equal to a diameter of the pivoting hole; and a width of the goods accommodating member is equal to a width of the accommodating opening.

16. The goods transmission apparatus of claim 15, wherein the plurality of accommodating spaces are configured to accommodate the sale items diagonally.
